(19) United States
(12) Patent Application Publication
(10) Pub. No.: US 2022/0177169 A1
(43) Pub. Date: Jun. 9, 2022

(54) Pharmaceutical Packaging System and Method of Manufacturing Same

(71) Applicant: GALDERMA HOLDING SA, Tour-de-Peilz (CH)

(72) Inventor: Karine Puyguiraud, Lausanne (CH)

(21) Appl. No.: 17/593,098

(22) PCT Filed: Mar. 17, 2020
(86) PCT No.: PCT/US20/23090

§ 371 Date: Sep. 9, 2021

(30) Foreign Application Priority Data
Mar. 18, 2019 (EP) 19163400.5

(51) Int. Cl. B65B 11/52; A61J 1/03; B65B 7/28

(52) U.S. Cl. CPC B65B 11/52; A61J 1/035; B65B 2230/02; B65B 7/2807; B65B 7/2878

(57) ABSTRACT

A pharmaceutical packaging system includes a substrate having a first surface, a first hollow cavity accessible through a first opening in the first surface, and a second hollow cavity accessible through a second opening in the first surface. The first and second hollow cavities are spaced apart and isolated from one another on the substrate. A cover is attached to at least a first portion of the first surface of the substrate surrounding the first opening and a second portion of the first surface of the substrate surrounding the second opening so as to provide a first seal for the first hollow cavity and a second seal for the second hollow cavity. At least one orally-administered medicament is contained within one of the first and second hollow cavities, and a first topically-applied medicament is contained within the other of the first and second hollow cavities.

### BACKGROUND OF THE INVENTION

Embodiments of the present invention are directed to a pharmaceutical packaging system, and more particularly, to a common pharmaceutical packaging system that houses both orally-administered and topically-applied medicaments in separately sealed cavities, and a method for manufacturing the pharmaceutical packaging system.

It is found that often a health or cosmetic regimen may require a patient to take or apply multiple medicaments in order to maximize the effect of treatment. As used herein, the term “medicament” refers to a substance used for medical or cosmetic treatment, which can be, for example, a medicine, a dietary or nutritional supplement (e.g., probiotics, vitamins, nutrients, and the like), a pharmaceutical or cosmetic composition, or the like.

While it would be convenient to package orally-administered and topically-applied medicaments belonging to a single regimen together in a common package, there are stiff obstacles. Most critical is the avoidance of contamination of the orally-administered medicament by non-oral ingredients or components. In particular, the risk of contamination of the orally-administered medicament by a chemical agent from a topically-applied medicament is very serious, as ingestion of such chemical agents can be dangerous.

It is therefore desirable to provide a pharmaceutical packaging system that contains both orally-administered and topically-applied medicaments that can be used together as part of a health or cosmetic regimen. It is further desirable to provide a method and system for manufacturing such a pharmaceutical packaging system that reduces or avoids the risk of cross-contamination among the various medicaments to be contained in the pharmaceutical packaging system.

### SUMMARY OF THE INVENTION

According to embodiments of the present invention, a pharmaceutical packaging system includes a substrate having a first surface, a first hollow cavity accessible through a first opening in the first surface, and a second hollow cavity accessible through a second opening in the first surface. The first and second hollow cavities may be spaced apart and isolated from one another on the substrate. A cover may be attached to at least a first portion of the first surface of the substrate surrounding the first opening and a second portion of the first surface of the substrate surrounding the second opening so as to provide a first seal for the first hollow cavity and a second seal for the second hollow cavity. At least one orally-administered medicament may be contained within one of the first and second hollow cavities, and a first topically-applied medicament may be contained within the other of the first and second hollow cavities.

The substrate is preferably made from one or more heat moldable polymeric materials. For example, the substrate can be formed from adhered or otherwise combined layers of polyethylene terephthalate (“PET”), ethylene vinyl alcohol (“EVOH”), and polyethylene (“PE”). The first and second cavities may be created during thermoforming of the substrate material to mold depressions or the like in the material. However, the substrate can be made from any suitable material or combination of materials that is approved for contact with orally-administered and topically-applied medicaments and can provide an adequate seal. While the first and second cavities are described above as being integrally formed in the substrate material, the first and second cavities can also be separate components that are adhered or otherwise attached to the substrate by a separate process.

The first and second hollow cavities are further preferably shaped to generally conform with the nature of their respective contents. For example, if the first hollow cavity contains a solid dosage form of orally-administered medicament, the first hollow cavity may generally have a similar, although slightly larger, shape in plan view. In one embodiment, the orally-administered medicament may be an elongated capsule, in which case the first hollow cavity may also use a similar elongated shape in plan view. In the case where, for example, multiple orally-administered medicaments are contained within the first hollow cavity, the first hollow cavity may take on any shape necessary to accommodate the plurality of dosage forms, vertically and/or horizontally. In another example, if the second hollow cavity contains a topically-applied cream, lotion, or the like, the second hollow cavity is preferably sized to accommodate a user's finger to allow the user to remove the medicament for application. In some embodiments, a portion of a bottom of the second hollow cavity may be tapered for easier retrieval by the user.

The cover is preferably made from a foil material. For example, the cover can be formed from a combination of metal and polymeric films, such as a combination of PET, aluminums, and PE. However, the cover can be made from any suitable material or combination of materials that is approved for contact with orally-administered and topically-applied medicaments, and which can be attached to the first surface of the substrate, or portions thereof, to provide a substantially fluid-tight seal for the hollow cavities. Limiting the sealing of the cover to portions of the first surface of the substrate surrounding the first and second openings, for example, simplifies manufacturing and makes it easier for the end user to remove the cover when the medicaments are to be used.

The cover is preferably attached to the substrate via heat sealing, although other similar processes may be used as well.

It is preferred that the orally-administered medicament be one of a capsule, tablet, or softgel, although other orally-administered medicament forms, such as a powder or the like, may be used as well. As an example, a single capsule may be contained within the first hollow cavity. As another example, two tablets may be contained within the first hollow cavity. The orally-administered medicament is preferably one of a probiotic, a nutricosmetic, a cosmeceutical, or a food or nutritional supplement, although any other types of orally-administered medicaments, for example, analgesics, antibiotics, anti-virals, antihistamines, and the like may be used as well. In particular, the at least one orally-administered medicament may be a nutricosmetic, a probiotic, or a combination of a nutricosmetic and a probiotic.

It is further preferred that the first topically-applied medicament be one of a serum, cream, lotion, ointment, paste, gel cream, or gel, although any other acceptable topically-applied forms may be used as well. The first topically-applied medicament is preferably a “day cream” formulated for anti-aging purposes with sun filters and specific ingredients for the skin protection, or a “night cream” formulated for hydration and anti-aging purposes, although any other types of topically-applied medicaments, for example analgesics, anti-fungals, antibiotics, topical retinoids, sunscreens, moisturizers, steroids, and the like may be used as well.

The substrate may include additional hollow cavities accessible through respective openings in the first surface, and which are each configured to receive a corresponding medicament that is sealed by the cover. For example, in some embodiments, the substrate further includes a third hollow cavity accessible through a third opening in the first surface. The third hollow cavity may be spaced apart and isolated from the first and second hollow cavities on the substrate. The third hollow cavity may be formed similar to the first and second hollow cavities. The cover may further be attached to at least a third portion of the first surface of the substrate surrounding the third opening so as to provide a third seal for the third hollow cavity. A second topically-applied medicament is preferably contained within the third hollow cavity.

It is further preferred that the second topically-applied medicament be one of a serum, cream, lotion, ointment, paste, gel cream, or gel, although any other acceptable topically-applied forms may be used as well. The second topically-applied medicament is preferably an oily skin serum formulated for oily skin or a dry skin serum formulated for dry skin, although any other types of topically-applied medicaments, for example analgesics, anti-fungals, antibiotics, topical retinoids, sunscreens, moisturizers, steroids, and the like may be used as well. It is further preferred that the first and second topically-applied medicaments be different from one another.

According to further embodiments of the present invention, a method for manufacturing the pharmaceutical packaging system and a packaging line for performing the method are also provided. The packaging line may include a first filling cabinet, into which is provided the substrate having the first surface, the first hollow cavity accessible through the first opening in the first surface, and the second hollow cavity accessible through the second opening in the second surface. As before, the first and second hollow cavities may be spaced apart and isolated from one another on the substrate. While the substrate is in the first filling cabinet, the at least one orally-administered medicament or the first topically-applied medicament may be fed into the first hollow cavity. The cover may be provided for the first surface and may be sealed to the first surface at a portion surrounding the first hollow cavity to provide the first seal. The substrate may be moved into a second filling cabinet of the packaging line, which may have a different internal pressure than the first filling cabinet. The cover may be partially moved away from the first surface of the substrate to expose the second hollow cavity. While the substrate is in the second filling cabinet, the other of the at least one orally-administered medicament or the first topically-applied medicament may be fed into the second hollow cavity. The cover may then be sealed to the first surface at a portion surrounding the second hollow cavity to provide the second seal.

The substrate may be provided as part of a web that contains a plurality of substrates. For example, the web may be a continuous roll of material used for the substrates, from which the substrates may be later cut, punched-out, or otherwise severed to create each individual pharmaceutical packaging system. The first and second hollow cavities for each substrate may be pre-formed on the roll, or may be formed while the web is traversing the packaging line prior to entering the first filling cabinet. The web may traverse the packaging line while supported on a conveyor belt, on individual rollers, combinations thereof, or the like.

The first filling cabinet preferably has a negative internal pressure therein. Such negative internal pressure can be provided by a vacuum or other air flow ventilation system designed to extract more air from the first filling cabinet than can enter, as is conventionally known. The internal pressure is preferably a minimum of 0.5 Pa. While the negative internal pressure is preferred, other internal pressures may be used, with the concept that the internal pressure within the first filling cabinet should be different from at least some of the other cabinets along the packaging line, in particular the second filling cabinet. In this way, air exchange between the first and second filling cabinets, where the various medicaments will be exposed, can be prevented.

Depending on the nature of the medicament to be dispensed, the first filling cabinet may include the necessary dispensing equipment. For example, in one embodiment, the first filling cabinet may feed the at least one orally-administered medicament into the first hollow cavity. Where the orally-administered medicament is a solid dosage form, for example, the first filling cabinet may include a hopper and one or more feeding tubes in communication with the hopper for leading one or more tablets, capsules, or the like into the first hollow cavity in the substrate. For increasing manufacturing capability, multiple feeding tubes are preferred so that multiple substrates can be fed generally simultaneously.

In another embodiment, for example, the first filling cabinet may feed the first topically-applied medicament into the first hollow cavity. Where the first topically-applied medicament is a cream, lotion, gel, or the like, the first filling cabinet may include one or more feeding tubes, each having a nozzle at an end thereof, for dispensing the first topically-applied medicament, which may be supplied from a chamber or an external feeding assembly. As with the orally-administered medicament, it may be beneficial to having multiple feeding tubes to feed multiple substrates generally simultaneously.

The cover may be provided as a continuous sheet that is applied to the substrate web. For example, a continuous sheet of foil may be provided on a roll that is led to the web via a conveyor belt, a series of rollers, combinations thereof, or the like. The cover sheet is preferably first brought into contact with the web at a location external to the first filling cabinet, which may be inside a first sealing cabinet, which may be provided between the first and second filling cabinets. However, the cover sheet may be brought into contact with the web inside the first filling cabinet downstream from where the first hollow cavity is filled. After the cover sheet meets the web, a first sealing head may create the first seal. As with the filling procedure, it may be advantageous if the first sealing head can create first seals on a plurality of substrates generally simultaneously.

Where the cover is provided as part of a sheet, it may be advantageous to at least partially sever the sheet after the first seal has been created. A partial severance ensures that each substrate can be associated with a “flap” containing a portion of its corresponding cover, which can be moved away from the substrate to expose the second hollow cavity. While the final cover may be trimmed away from the sheet at this stage, it may be complex and time consuming to achieve the final cover shape, and so it can be more beneficial to make a single cut in the sheet adjacent to a substrate in the packaging line in order to keep the line moving. The extent of severing of the cover from the sheet can also be dependent on the procedure for exposing the second hollow cavity downstream. The first sealing cabinet may be provided with a first cutting tool to accomplish the severing task. As with previously described procedures, it may be advantageous if the first cutting tool can create multiple cuts in the sheet generally simultaneously.

To partially move the cover away from the first surface of the substrate, a vacuum suction head may be provided. The vacuum suction head may be configured to lower onto the cover, attach thereto using suction, and lift away from the substrate, taking the cover with it, leaving a space between the cover and the portion of the substrate surface having the second opening leading to the second hollow cavity. Alternatively, the vacuum suction head may be positioned sufficiently close to the cover such that the vacuum force is sufficient to attract the cover material thereto from a fixed position. In the case described above, where the cover is supplied as a continuous sheet and a cut is made in the sheet to create a “flap” of material, the vacuum suction head may lift the flap, which may expose multiple substrates at once. A remaining portion of the cover may be held in place during this procedure by virtue of the first seal. In conjunction with the vacuum suction head, a cam rail may also be provided, which is preferably capable of maintaining exposure of the second hollow cavity (and any additional relevant hollow cavities) until after the second hollow cavity (and any other relevant hollow cavities) has been filled. In essence, the cam rail may take over for the vacuum suction head as the substrate moves downstream within the packaging line. The cam rail may not only maintain exposure of the second hollow cavity, but may further manipulate the cover to increase access to the second hollow cavity or the like by, for example, folding the cover away from the second opening in the substrate. The vacuum head may move laterally with the web toward the cam rail, whereupon suction may be released after the cover is transferred over to the cam rail. The vacuum suction head may then reverse direction and return to its starting position to attach with another cover. Alternatively, the vacuum suction head may be positioned sufficiently close to the cam rail that the raised “flap” can engage the cam rail during continued travel of the sheet without requiring movement of the vacuum suction head.

While the cover is described above as being partially moved away from the substrate by use of a vacuum suction head and cam rail assembly, other techniques may be used as well in keeping with the invention. Moreover, the cover may be individually supplied for each substrate, rather than as part of a sheet, and each individual cover would then be partially moved away from the substrate surface in a manner similar to that described above.

It is further preferred that the vacuum suction head and cam rail, or other components performing similar functionality, be located within the second filling cabinet. However, such components can also be located outside of the second filling cabinet, or may have portions located both inside and outside of the second filling cabinet.

The second filling cabinet preferably has a positive internal pressure therein. Such positive internal pressure can be provided by a blower or air flow ventilation system designed to force more air into the second filling cabinet than can enter, as is conventionally known. The internal pressure is preferably a minimum of +0.5 Pa. While the positive internal pressure is preferred, other internal pressures may be used, with the concept that the internal pressure within the second filling cabinet should be different from at least some of the other cabinets along the packaging line, in particular the first filling cabinet.

The second filling cabinet may include the necessary dispensing equipment for feeding the other of the at least one orally-administered medicament or the first topically-applied medicament into the second hollow cavity. Such equipment has been described above for both orally-administered and topically-applied medicaments. For increasing manufacturing capability, multiple feeding tubes are preferred so that multiple substrates can be fed generally simultaneously.

Following the filling of the second hollow cavity, the cover may be allowed to return to its position in contact with the substrate surface. This may occur either inside of the second filling cabinet or externally thereto, such as, for example, within a second sealing cabinet located downstream of the second filling cabinet. The second sealing cabinet may be provided with a second sealing head, similar to the first sealing head, which completes the second seal by attaching the cover to the portion of the substrate surface surrounding the second opening to the second hollow cavity. As with the previous procedures, it may be advantageous if the second sealing head can create second seals on a plurality of substrates generally simultaneously.

The second sealing cabinet may further include a second cutting tool that may pre-cut the substrate so that various portions thereof can be easily detached by the user. For example, portions of the substrate having the first and second hollow cavities may be separable from one another if the user so chooses. The second sealing cabinet may also include a third cutting tool that may be responsible for final separation of the substrate from the web and/or the cover from the continuous sheet.

In embodiments where the substrate includes additional hollow cavities configured to receive various medicaments, the packaging line described above may be modified to include additional equipment, cabinets, or the like to accommodate the additional processing steps needed. For example, in the embodiment where the substrate includes the third hollow cavity for receiving the second topically-applied medicament, the filling cabinet responsible for feeding the first topically-applied medicament to the substrate can be modified to include a second set of feeding tubes and nozzles for dispensing the second topically-applied medicament. In embodiments where the first and second topically-applied medicaments are dispensed in the second filling cabinet, when the cover is partially moved away from the substrate, the third hollow cavity is preferably also exposed as a result. Preferably, the first and second topically-applied medicaments can be fed generally simultaneously. Similarly, the first or second sealing head may be used to create the third seal, as necessary, depending on which filling cabinet is responsible for feeding of the second topically-applied medicament. Alternatively, the second topically-applied medicament can have its own separate filling and/or sealing cabinets.

The packaging line according to embodiments of the present invention is not limited to the configurations described above. For example, the first and second filling cabinets can include more or fewer components, perform additional operations, and may or may not be joined by a common conveyor. As another example, the sealing heads may be utilized within the respective filling cabinets as opposed to having separate sealing cabinets. Cutting tools may also have their own cabinets, be external to any cabinets on a packaging line, or be located within filling cabinets. As another example, one or more cabinets may include machine vision cameras to observe proper placement of medicaments in their respective hollow cavities.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a bottom perspective view of a pharmaceutical packaging system in accordance with a preferred embodiment of the present invention;

FIG. 2 is a top plan view of the pharmaceutical packaging system of FIG. 1 with the cover removed;

FIG. 3 is a bottom plan view of a pharmaceutical packaging system in accordance with another preferred embodiment of the present invention;

FIG. 4 is a top plan schematic view of a web for manufacturing the pharmaceutical packaging system in accordance with another preferred embodiment of the present invention;

FIG. 5 is a front side elevational view of a packaging line for manufacturing the pharmaceutical packaging system in accordance with another preferred embodiment of the present invention;

FIG. 6 is a front side perspective view of a second filling cabinet of the packaging line of FIG. 5;

FIG. 7 is a front side elevational view of a first filling cabinet of the packaging line of FIG. 5; and

FIG. 8 is a front side elevational view of a first sealing cabinet of the packaging line of FIG. 5.

### DETAILED DESCRIPTION OF THE INVENTION

Certain terminology is used in the following description for convenience only and is not limiting. The words “right,” “left,” “lower” and “upper” designate directions in the drawings to which the reference is made. The words “inwardly” and “outwardly” refer to directions toward and away from, respectively, the geometric center of the apparatus and designated parts thereof. The terminology includes the words above specifically mentioned, derivatives thereof and words of similar import.

It should also be understood that the terms “about,” “approximately,” “generally,” “substantially” and like terms, used herein when referring to a dimension or characteristic of a component of the invention, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

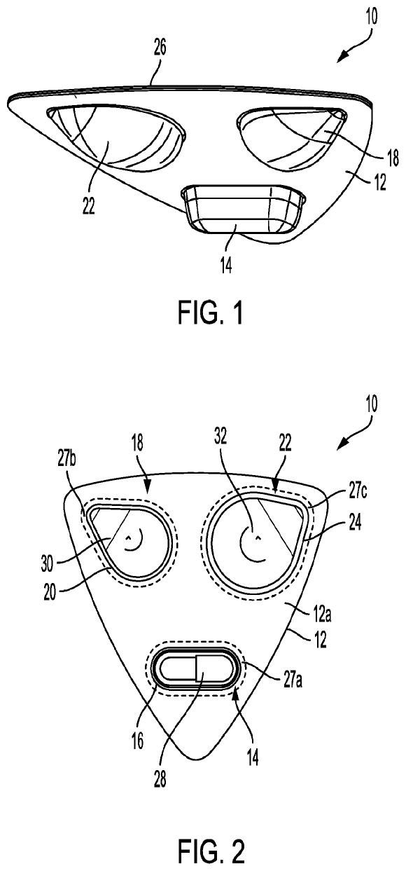

Referring to FIGS. 1 and 2, there is shown an example of a pharmaceutical packaging system 10 in accordance with a preferred embodiment of the present invention. The pharmaceutical packaging system 10 includes a substrate 12 having a first surface 12a. A first hollow cavity 14 is formed in the substrate 12 and is accessible through a first opening 16 in the first surface 12a. A second hollow cavity 18 is formed in the substrate 12 and is accessible through a second opening 20 in the first surface 12a. A third hollow cavity 22 is formed in the substrate 12 and is accessible through a third opening 24 in the first surface 12a.

A cover 26 is placed on the first surface 12a of the substrate 12. The cover 26 is at least adhered to first, second, and third portions 27a, 27b, 27c of the first surface 12a. In FIG. 2, the cover 26 is removed, and the first, second, and third portions 27a, 27b, 27c of the first surface 12a are respectively delimited by dashed lines around each of the first, second, and third openings 16, 20, and 24. Connection of the cover 26 to the first, second, and third portions 27a, 27b, 27c thereby provides first, second, and third seals to prevent the ingress or egress of air with respect to the first, second, and third hollow cavities 14, 18, 22.

In the example of FIG. 2, the first hollow cavity 14 contains a capsule 28 of a nutricosmetic. The second hollow cavity 18 contains an anti-aging day cream 30. The third hollow cavity 22 contains an oily or dry skin serum 32.

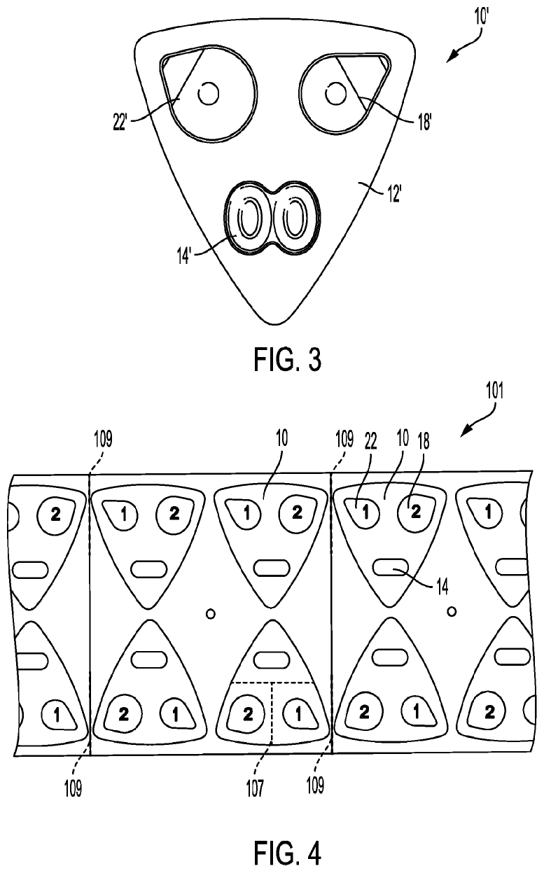

FIG. 3 shows an alternative embodiment of a pharmaceutical packaging system 10′, having a substrate 12′ with first, second, and third hollow cavities 14′, 18′, and 22′. In this embodiment, the first hollow cavity 14′ is sized and shaped to accommodate two tablets of a nutricosmetic (not shown) stored side-by-side. The second hollow cavity 18′ contains a hydrating and anti-aging night cream (not shown). The third hollow cavity 22′ contains an oily or dry skin serum (not shown).

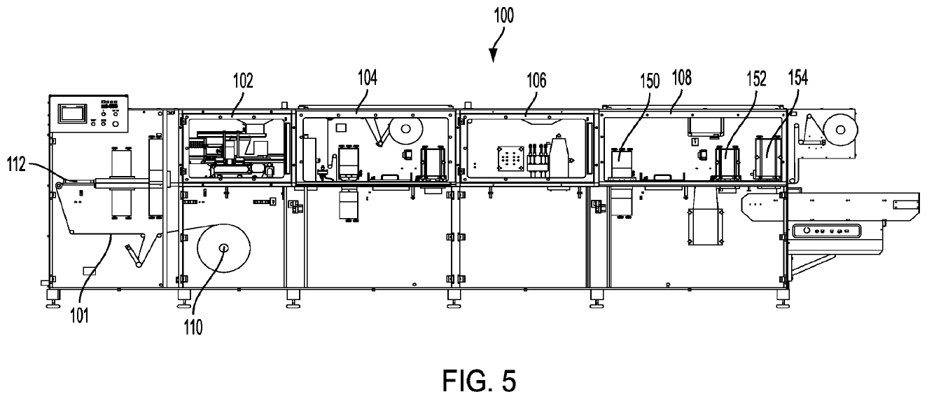

Referring to FIG. 5, there is shown a packaging line 100 for manufacturing the pharmaceutical packaging system 10 in accordance with a preferred embodiment of the present invention. The packaging line 100 includes, in a downstream order, a first filling cabinet 102, a first sealing cabinet 104, a second filling cabinet 106, and a second sealing cabinet 108. Substrates 12 are provided as part of a web 101 (FIG. 4) from a roll 110, which is moved between the various cabinets 102, 104, 106, 108 by a conveyor belt 112. As seen in FIG. 4, the web 101 includes a plurality of substrates 12 arranged in two rows extending in the travel direction of the web 101.

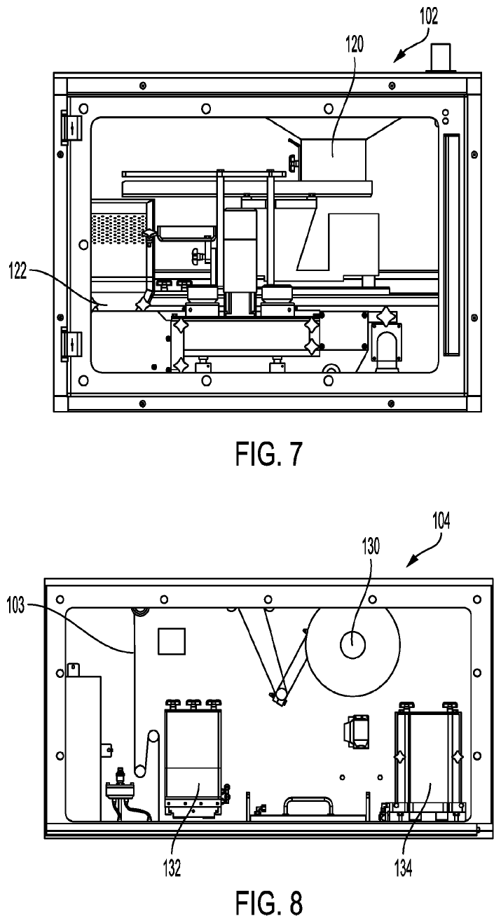

The first filling cabinet 102 is shown in greater detail in FIG. 7. The first filling cabinet 102 is kept at a negative internal pressure by an air flow ventilation system (not shown). In the present embodiment shown, the first filling cabinet 102 is responsible for feeding the orally-administered medicament 28 into the first hollow cavity 14 of the substrate 12. Accordingly, the first filling cabinet 102 includes a hopper 120 in which capsules, tablets, or the like 28 may be placed in bulk for alignment and disbursement. A feeding tube 122 is connected to the hopper 120 for receiving the capsules, tablets, or the like and transporting them to the first hollow cavity 14 of each substrate 12.

After receiving the orally-administered medicament 28, the substrate 12 exits the first filling cabinet 102 and proceeds to the first sealing cabinet 104, shown in greater detail in FIG. 8. The first sealing cabinet 104 supplies the cover 26 as a continuous sheet 103 on a roll 130. The sheet 103 is brought into contact with the web 101 just prior to the web 101 being subjected to a first sealing head 132. In the embodiment shown, the first sealing head 132 is configured to create the first seal on four substrates 12 at a time, i.e., two adjacent substrates 12 in one row and two correspondingly adjacent substrates 12 in the second row of the web 101. Downstream of the first sealing head 132 is a first cutting tool 134 configured to partially sever the sheet 103 and the web 101 at the cut locations 109 shown in FIG. 4. In particular, a partial cut is made from an edge of the web 101 between every two substrates 12 in each row.

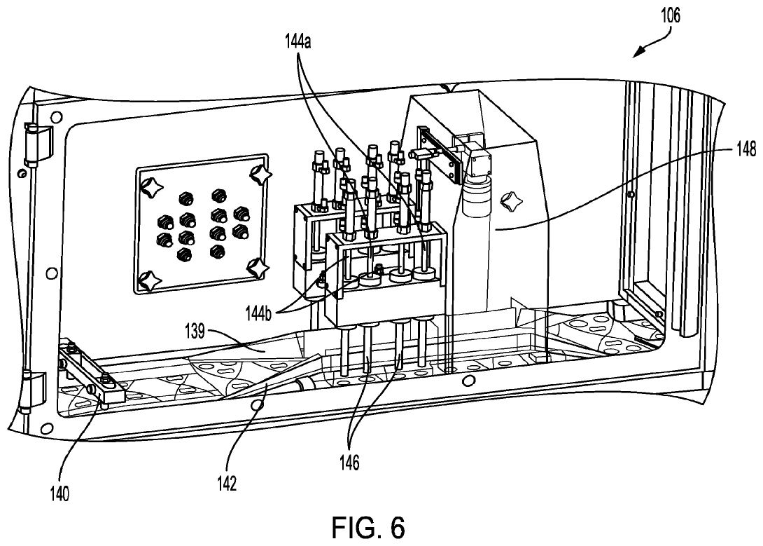

Upon exiting the first sealing cabinet 104, the substrate 12 enters the second filling cabinet 106, which is shown in greater detail in FIG. 6. The second filling cabinet 106 is kept at a positive internal pressure by an air ventilation system (not shown), thereby preventing air exchange between the first and second filling cabinets 102, 106. Near the entrance to the second filling cabinet 106 there is a vacuum suction head 140. The vacuum suction head 140 adheres to the cover sheet 103 near opposing edges thereof, to lift the edges of the cover sheet 103 away from the web 101. The locations of the cuts 109 (FIG. 4) ensures that only a portion of the cover sheet 103 overlying four adjacent substrates 12 on the web 101 is lifted at a time by the vacuum suction head 140. The action of raising the edges of the cover sheet 103 allows “flaps” 139 to engage opposing cam rails 142, each of which initially angle toward a center of the web 101, further lifting the cover sheet 103 away from the substrates 12 so as to expose the second and third hollow cavities 18, 22, thereof.

In the present embodiment shown, the second filling cabinet 106 is responsible for feeding the first and second topically-applied medicaments 30, 32 respectively into the second and third hollow cavities 18, 22 of the substrate 12. Accordingly, the second filling cabinet 106 includes a plurality of feeding tubes 144a, 144b, each having a nozzle 146. One set of the feeding tubes 144a supplies the first topically-applied medicament 30 while a second set of the feeding tubes 144b supplies the second topically-applied medicament 32. Preferably, each set includes four feeding tubes 144a, 144b, so that four substrates 12 can be filled generally simultaneously. The feeding tubes 144a, 144b are connected to one or more chambers 148 to supply the first and second topically-applied medicaments 30, 32. The cam rail 142 extends behind the nozzles 146 to allow access to the second and third hollow cavities 18, 22. After the second and third hollow cavities 18, 22 have been filled, each cam rail 142 angles back towards an edge of the web 101, allowing the “flap” 139 to lower and the cover sheet 103 to come back into contact with the web 101 as the substrate 12 exits the second filling cabinet 106.

Downstream of the second filling cabinet 106, the substrate 12 enters the second sealing cabinet 108. Much like the first sealing cabinet 104, the second sealing cabinet 108 includes a second sealing head 150, which is used to create the second and third seals on four substrates 12 at a time. A second cutting tool 152 is also provided, which applies pre-cuts 107 (FIG. 4) to the substrates 12, to allow later separation by an end user of individual portions of the substrate 12. A third cutting tool 154, near a downstream exit of the second sealing cabinet 108, performs final separation of the substrate 12 from the web 101 and cover 26 from the sheet 103 into the final triangular shape shown in FIGS. 1 and 2.

Those skilled in the art will recognize that boundaries between the above-described operations are merely illustrative. The multiple operations may be combined into a single operation, a single operation may be distributed in additional operations and operations may be executed at least partially overlapping in time. Further, alternative embodiments may include multiple instances of a particular operation, and the order of operations may be altered in various other embodiments.

It will be appreciated by those skilled in the art that changes can be made to the embodiments described above without departing from the broad inventive concept of the invention. It is understood, therefore, that this invention is not limited to the particular embodiments disclosed, but it is intended to cover modifications within the spirit and scope of the present invention.

1. A pharmaceutical packaging system comprising:
a substrate having a first surface, a first hollow cavity accessible through a first opening in the first surface, and a second hollow cavity accessible through a second opening in the first surface, the first and second hollow cavities being spaced apart and isolated from one another on the substrate;
a cover attached to at least a first portion of the first surface of the substrate surrounding the first opening and a second portion of the first surface of the substrate surrounding the second opening so as to provide a first seal for the first hollow cavity and a second seal for the second hollow cavity; at least one orally-administered medicament contained within one of the first and second hollow cavities; and
a first topically-applied medicament contained within the other of the first and second hollow cavities.

2. The pharmaceutical packaging system of claim 1, wherein the substrate further includes a third hollow cavity accessible through a third opening in the first surface, the third hollow cavity being spaced apart and isolated from the first and second hollow cavities on the substrate,
wherein the cover is attached to at least a third portion of the first surface of the substrate surrounding the third opening so as to provide a third seal for the third hollow cavity, and
further comprising a second topically-applied medicament contained within the third hollow cavity.

3. The pharmaceutical packaging system of claim 1, wherein the at least one orally-administered medicament is one of a capsule, tablet, or soft-gel.

4. The pharmaceutical packaging system of claim 1, wherein the at least one orally-administered medicament is one of a probiotic or a food or nutrient supplement.

5. The pharmaceutical packaging system of claim 1, wherein the at least one orally-administered medicament is a nutricosmetic.

6. The pharmaceutical packaging system of claim 1, wherein the first topically applied medicament is one of a serum, cream, lotion, ointment, paste, or gel.

7. The pharmaceutical packaging system of claim 1, wherein the first topically applied medicament is an anti-aging day cream or a hydrating and anti-aging night cream.

8. The pharmaceutical packaging system of claim 2, wherein the second topically applied medicament is one of a serum, cream, lotion, ointment, paste, or gel.

9. The pharmaceutical packaging system of claim 2, wherein the second topically applied medicament is an oily or dry skin serum.

10. A method of manufacturing a pharmaceutical packaging system containing at least one orally-administered medicament and a first topically-applied medicament, the method comprising:
providing, into a first filling cabinet, a substrate having a first surface, a first hollow cavity accessible through a first opening in the first surface, and a second hollow cavity accessible through a second opening in the first surface, the first and second hollow cavities being spaced apart and isolated from one another on the substrate;
feeding, while the substrate is in the first filling cabinet, the at least one orally-administered medicament or the first topically-applied medicament into the first hollow cavity; providing a cover for the first surface of the substrate and sealing the cover to the first surface of the substrate at a portion surrounding the first hollow cavity to provide a first seal;
providing the substrate into a second filling cabinet having a different internal pressure than the first filling cabinet;
partially moving the cover away from the first surface of the substrate to expose the second hollow cavity;
feeding, while the substrate is in the second filling cabinet, the other of the at least one orally-administered medicament or the first topically-applied medicament into the second hollow cavity; and
sealing the cover to the first surface of the substrate at a portion surrounding the second hollow cavity to provide a second seal.

11. The method of manufacturing a pharmaceutical packaging system of claim 10, wherein the first topically-applied medicament is fed into the second hollow cavity, and wherein the substrate includes a third hollow cavity accessible through a third opening in the first surface, the third hollow cavity being spaced apart and isolated from the first and second hollow cavities on the substrate, the method further comprising:
exposing the third hollow cavity when the cover is partially moved away from the first surface of the substrate;
feeding, while the substrate is in the second filling cabinet, a second topically-applied medicament into the third hollow cavity; and
sealing the cover to the first surface of the substrate at a portion surrounding the third hollow cavity to provide a third seal.

12. The method of manufacturing a pharmaceutical packaging system of claim 10, wherein the second filling cabinet includes a vacuum suction head configured to attach to the cover for partially moving the cover away from the first surface of the substrate, and a cam rail configured to maintain the cover in a position exposing the second hollow cavity until after the other of the at least one orally-administered medicament or the first topically-applied medicament has been fed into the second hollow cavity.

13. The method of manufacturing a pharmaceutical packaging system of claim 10, further comprising:
providing a negative internal pressure within the first filling cabinet; and
providing a positive internal pressure within the second filling cabinet.

14. The method of manufacturing a pharmaceutical packaging system of claim 13, wherein a first sealing cabinet is provided between the first and second filling cabinets, and wherein the step of providing the cover and sealing the cover to the first surface of the substrate to provide the first seal is performed within the first sealing cabinet.

15. The method of manufacturing a pharmaceutical packaging system of claim 10, wherein the substrate is provided as part of a web containing a plurality of substrates and the cover is provided as a continuous sheet applied to the web, the method further comprising:
partially severing the sheet before the substrate enters the second filling cabinet so as to allow the cover to be partially moved away from the first surface of the substrate.
